(19) United States
(12) Patent Application Publication
(10) Pub. No.: US 2021/0186263 A1
(43) Pub. Date: Jun. 24, 2021

(54) ASSEMBLY OF A SUPPORT FRAME AND A FOOD PREPARATION APPARATUS

(71) Applicant: barbacoa.PRO B.V., Nieuw-Vennep (NL)

(72) Inventor: Johannes Henricus Petrus DE BEER, Nieuw-Vennep (NL)

(21) Appl. No.: 17/270,986

(22) PCT Filed: Aug. 26, 2019
(86) PCT No.: PCT/NL2019/050548

§ 371 Date: Feb. 24, 2021

(30) Foreign Application Priority Data
Aug. 24, 2018 (NL) 2021494

(51) Int. Cl. A47J 37/07

(52) U.S. Cl. CPC A47J 37/0786; A47J 2037/0777; A47J 37/0763; A47J 37/0718

(57) ABSTRACT

Described is an assembly of a support frame and a food preparation apparatus, which food preparation apparatus comprises a bowl member the upper side of which is open, which bowl member comprises a bottom and a convexly running sidewall and which has a substantially annular cross-section at the open upper side, wherein the bowl member defines an internal heating space, wherein the bowl member is borne by the support frame characterized in that the support frame comprises five bearing elements that are positioned at a regular distance from each other and extend vertically along the height of the bowl member, which bearing elements secure the bowl member in the support frame, and the five bearing elements are interconnected by one or more horizontally extending connecting elements, which bearing elements are connected to one or more base elements, on which the food preparation apparatus, when being used, rests on the ground, wherein the bowl member is borne by the bearing elements and the one or more base elements.

The invention relates to an assembly of a support frame and a food preparation apparatus, which food preparation apparatus comprises a bowl member the upper side of which is open, which bowl member comprises a bottom and a convexly running sidewall and which has a substantially annular cross-section at the open upper side, wherein the bowl member defines an internal heating space, wherein the bowl member is borne by the support frame that is provided with vertically extending bearing elements that are interconnected by one or more horizontally extending connecting elements, which bearing elements comprise base elements at their bottom sides, on which bearing elements the assembly, when being used, rests on the ground. The assembly is particularly intended for outdoor use.

Food preparation apparatuses of the above-mentioned type are known in the art, such as the kamado-type grill, as made commercially available by Big Green Egg (Alresford, UK), Kamado Joe (Duluth, Ga., US) and The Bastard (Haarlem, the Netherlands). Such grills are more or less egg-shaped and made of ceramic material. A more or less spherical bowl is hingedly connected to an egg-shaped lid. In the bowl, charcoal or another suitable fueling means is lit, at the open side of the bowl member a gridiron for, as a rule, grilling meat is positioned and held by for instance the upper edge of the bowl member, and the lid is able to close off the space. Such an apparatus usually comprises a support frame as described above in which the bowl is borne and kept spaced apart from the ground. Such a frame usually comprises three or four bearing elements that are connected to each other and which at their bottom sides comprise a base with which the apparatus rests on the ground. Because of the considerable weight of such a frame the apparatus usually comprises casters to facilitate movement. More deluxe varieties are provided with one or two small shelves situated along the side of the bowl, which shelves serve as small bearing surfaces on which grill or barbeque necessities can be placed.

US2018/0078090 for instance, describes a cart having a rectangular horizontal bearing surface on the corner points of which there are vertically extending bearing elements, two of which at the bottom side are provided with two wheels connected to each other by an axle, and two of which are provided with casters. The grill sits on the bearing surface. From the bearing surface, beam-shaped elements that have no bearing function extend upwards from the corner points, of which elements each time two are connected to each other at their outer ends via a horizontal handle by which the cart can be wheeled around. Because two wheels are connected to each other via a rigid axle, it is difficult to maneuver the cart.

Assemblies including more lightweight barbecues and grills are also known, such as enameled metal versions of Weber (Palatine, Ill., USA). Due to the relatively low weight, the support frame is limited to three legs extending to the ground from the bottom of the bowl, that means not along the height of the bowl. Between the legs a metal bowl is sometimes placed underneath the grill.

WO2014/001115 also describes a block-shaped grill cart, which at the corner points is provided with casters at the bottom side. Such a solution may make maneuvering easier, however, the cart is unsuitable for heavy grills such as the kamado-type ceramic grill. Due to the grill's relatively high center of gravity, the risk of the cart tilting when being moved is high, which may be dangerous, particularly when the grill is burning or still hot. WO 2011/0079209 also describes a grill cart in which a relatively lightweight grill is accommodated in a tube frame having four legs, of which two legs have wheels that are connected to each other by a rigid axle. The other two legs have no wheels. This cart as well is hard to maneuver.

From WO2010/118062 a kamado-type grill is known that stands on three legs that are attached to the exterior wall of the bowl member sidewall.

The invention provides an improved assembly of a support frame and a food preparation apparatus of the above-mentioned type with which the stability and maneuverability are considerably improved. For that purpose, the support frame comprises five bearing elements that are positioned at a regular distance from each other and extend vertically along the height of the bowl member, which bearing elements bear and secure the bowl member in the support frame.

The support frames known to date usually comprise three or four bearing elements, at their bottom sides having three or four base elements, respectively, for instance rubber legs or castors that may or may not have a brake. By configuring the support frame with five bearing elements, a support frame can be provided with five base elements, such as legs or castors, which improves the stability to a high extent. Particularly when wheeling a known apparatus with a frame having four castors, there is a considerable risk of the apparatus keeling over due to its weight and being damaged in the process. This risk will be much lower in case there are five castors. Moreover, in this embodiment the bearing elements are at an angle of 72°.

Because the bearing elements extend along the height of the bowl member, the bearing elements form a cavity in which the bowl member is accommodated.

Because the bearing elements are interconnected by the connecting elements, the frame forms a solid and firm unity as a result of which the bowl member is secured in the frame.

In an advantageous embodiment one or more first connecting elements extend such at the location of the bottom side of the bowl member, that the bottom of the bowl member rests on these first connecting elements. Such a connecting element may be configured as a rod or profile section connecting two or more of the bearing elements to each other, and preferably connecting all bearing elements of the frame to each other. In case of five or more bearing elements, the connecting element is advantageously configured star-shaped, wherein the star-shape has a number of arms corresponding to the number of bearing elements. The bearing elements will then each time be connected to a tip of the star-shape, as a result of which the bearing elements are interconnected for the requisite firm and rigid structure.

The bearing elements that are connected may also comprise a circular or angular element, or be bowl-shaped, wherein the bearing elements are for instance attached against the outer circumference thereof. A bowl can also rest on the connecting elements. The bottom of the bowl may also be truncated and have a flat bottom. In that case providing a plate-shaped connecting element can be opted for, for instance in the shape of a pentagon, with which the bearing elements can be connected to each other and on which the bowl member can rest.

However, the connecting elements can also be spaced apart from the bottom side of the bowl member, as a result of which the bowl member does not rest on these connecting elements. In that case, the bowl member will rest against the bearing elements. The bowl member will in such cases exert an outwardly directed force on the frame. To counteract the bearing arms giving way, it may be opted for to connect the bearing arms to each other at the location of the bowl member via an annular connecting element extending around the exterior of the bowl member.

To ensure the stability, it is advantageous that in addition to the above-mentioned first connecting elements on which the bowl member rests when used, the support frame comprises second connecting elements, which second connecting elements are placed below and spaced apart from the bottom of the bowl member. In that way, the bearing elements can be firmly connected to each other near the ground in order to guarantee more firmness. The second connecting elements can be configured like the first, as described above. In an attractive embodiment, the second connecting elements are located near the base elements of the support frame, and a plate may for instance be placed on them on which plate grill necessities can be kept.

The above-mentioned connecting elements may comprise slidable arms, for thus being able to set off varying dimensions of the bowl member. In that way, manufacturing a specific support frame for each new type of bowl of a different size, will not be necessary. The length of its connecting elements or its arms can be adjusted to the dimensions of the bowl member and be secured in the wanted length in a manner known to the expert.

In a specific embodiment, the bearing elements extend substantially along the sidewall of the bowl member. In that way, the bowl is secured in the support frame in an optimal fashion and the risk of the bowl shifting in the support frame is practically impossible. The bearing elements can be configured such that they at least in part, but preferably in full, follow the curvature of the exterior of the sidewall of the bowl member and as a consequence at least in part, or in full, respectively, contact its surface. The bearing elements can also be configured straight or less curved, as a result of which the bearing elements do not fully abut the bowl. In that case, the bearing elements are placed at an angle to the vertical, in order to minimize the distance to the bowl if possible. Nevertheless, the bowl will be sufficiently secured in this way. At the location of the bearing elements, the bowl may also have a straight recess along its length in order to be able to abut a straight bearing element in that way.

The bearing elements may also extend vertically only. In that case, the bearing elements extend at substantially 90° to the plane of the open side of the bowl member and the distance between the bearing elements and the bowl member further increases in downward direction because of its convex configuration. In that case, the bowl will need to be secured within the support frame in a different way, for instance by placing a horizontally extending annular element connecting the bearing elements to each other, which annular element has a diameter that is smaller than the maximum diameter of the bowl so that the bowl can be placed in the ring and rest against it. The bearing surface will then for instance be supported by one or two bearing elements.

In an advantageous embodiment the bearing element comprises a combination of both embodiments discussed above and for that purpose it comprises an interior bearing part extending substantially along the wall of the bowl member, and being connected to an exterior bearing part extending at substantially 90° to the plane of the open side of the bowl member. In this embodiment, optimal firmness is obtained by the vertical exterior bearing parts, whereas optimal securing of the bowl in the support frame is obtained by the interior bearing parts. These interior and exterior bearing parts are connected to each other to ensure optimal firmness.

The bearing elements preferably extend to beyond the bottom of the bowl in a direction facing away from the bowl member, for in that way ensuring ground clearance for the bowl member when used. The bearing elements then also acquire the function of “legs”.

In a highly attractive embodiment, at the outer circumference of the bowl member, the assembly at least comprises a bearing surface extending to the outside and substantially parallel to the open side of the bowl member, wherein one or more bearing elements support the at least one bearing surface. In the known kamado-type grills, such bearing surfaces, usually in the form of shelves, are attached to the bowl via a ring encircling the bowl at the location of its open side. However, this construction only permits limited loads and for that reason the shelves have up until now been configured having highly limited dimensions. Placing a load on such shelves also causes pressure on the ceramic material of the bowl element, and the material may crack or burst, particularly if the exterior of the ceramic material has been glazed. The glaze often gets damaged due to the known ring structure. Moreover, such a shelf provides hardly any room for a helping of meat to be grilled to be placed thereon. Support frames of known apparatuses may indeed already comprise bearing elements extending in vertical direction along the height of the bowl, but they usually only extend up to certain height along the bowl and have no further bearing function for any bearing surface, such as a shelf, that may be present. Because of this embodiment of the invention, bearing elements support a bearing surface and a lot more force can be exerted on such a bearing surface. By ‘support’ is meant that the bearing elements are connected to the bearing surface in question, or that the bearing surface can rest on the bearing elements. A shelf may for instance be attached to a bearing element, for example by attaching a horizontal support to the bearing element, to which the shelf can be attached.

Advantageously, at least two bearing elements support the at least one bearing surface on either side of its axial line. The bearing elements are then positioned on either side of the axial line of the bearing surface. By supporting a bearing surface on either side of its axial line, preferably near its radial sides, an optimal support is provided.

Due to the presence of five bearing elements that are positioned at a regular distance from each other, four of those bearing elements are able to support two bearing surfaces that are placed opposite each other in the manner described above, and one bearing element can remain free. During use, this ‘free’ bearing element can be oriented rearward, wherein the user standing in front of the apparatus has two shelves, that face the user, at his disposal. In this case, two bearing elements situated next to each other each support a bearing surface on either side of its axial line, as already described above.

In an attractive manner, the one or more bearing elements supporting the bearing surface extend as far as the open side of the bowl member. In this embodiment the bearing elements extend as far as the upper side of the bowl, that means as far as the height at which the gridiron is situated, and usually at the location where the diameter of the apparatus is largest. This height usually is the working height of the apparatus. By having the bearing elements extend as far as this height, bearing surfaces can easily be attached at this height and be supported by the bearing elements.

In an attractive embodiment the one or more bearing elements supporting the bearing surface or bearing surfaces can be adjusted in height. As a result, the shelves can be adjusted to the correct height, depending on how tall the user is. In an attractive embodiment, all bearing elements can be adjusted in height, in which way the accommodation and securing of different dimensions of bowl members is enabled. Particularly in combination with the adjustable connecting elements described above, a frame is provided that is suitable for bowl members of several dimensions.

Advantageously the one or more bearing elements supporting a bearing surface each comprise a bearing arm, which bearing arm extends substantially parallel to the open side of the bowl member, on which bearing arm the bearing surface is placed. As the bearing part extends in vertical direction and the bearing arm part extends in horizontal direction, at the location of the transition of the vertically running portion and the bearing arm portion the bearing arm has such an angle to the bearing element, that the bearing element runs horizontally when being used. If so desired and advantageously, use can be made to that end of an angular element for providing a connection between the vertical and the horizontal portion of the bearing part. For that purpose, the one or more bearing elements supporting the bearing surface each comprise an angular element, which angular element is connected to a bearing arm. In case the bearing element is fully vertical, the arm is at an angle of 90° to the angular element.

The angular element preferably is configured so as to be rotatable relative to the bowl member. By designing it so as to be rotatable in horizontal direction, shelves of various dimensions can be placed on the bearing arms. The angular elements can also be designed so as to be detachable from the bearing element, in order to enable easy removal of the shelves including the angular elements in that way, for instance for cleaning purposes. By designing the angular elements so as to be rotatable in vertical direction, the shelves can be folded up or folded down, which results in the saving of space when the assembly is not being used.

In an attractive embodiment the rotatable arm of the angular element, which arm can be hinged horizontally, makes a curvature that substantially corresponds to the outer circumference of the bowl member at the location of the angular element. In that case the arm, when the shelf has been detached from it, can be rotated against the bowl, and as the curvature of the arm corresponds to the curvature of the bowl, the arm is able to abut the bowl in a manner so as to save space.

The apparatus preferably comprises a lid with which the open side of the bowl member can be closed off. In case of a support frame having five legs, that means a support frame having five bearing elements as described above, the lid can be placed such that the hinge is situated above the rearmost leg, so that the four other legs are available for supporting two shelves facing the user, wherein the fifth leg guarantees the stability when opening the lid. The lid preferably has a convex shape; such a lid shape is beneficial to the preparation performances. The food preparation apparatus preferably is a barbecue or grill, preferably of the kamado-type, although any food preparation apparatus with a convex shape having an internal heating space is suitable.

The invention also relates to a support frame suitable to be used in an assembly as described above, as well as to a support frame as described herein.

The invention will be elucidated below on the basis of the figures.

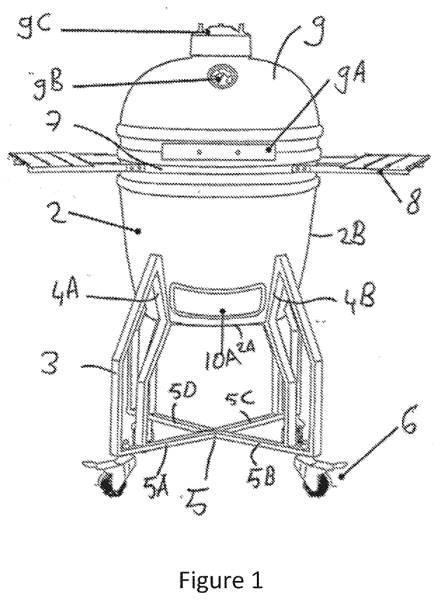

FIG. 1 shows a schematic view of an assembly of a support frame and a food preparation apparatus according to the state of the art;

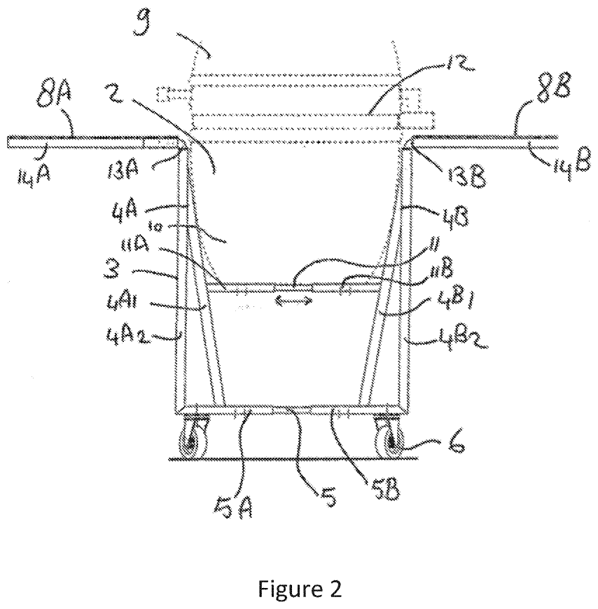

FIG. 2 shows a side view of a support frame of an assembly of a support frame and a food preparation apparatus according to the invention;

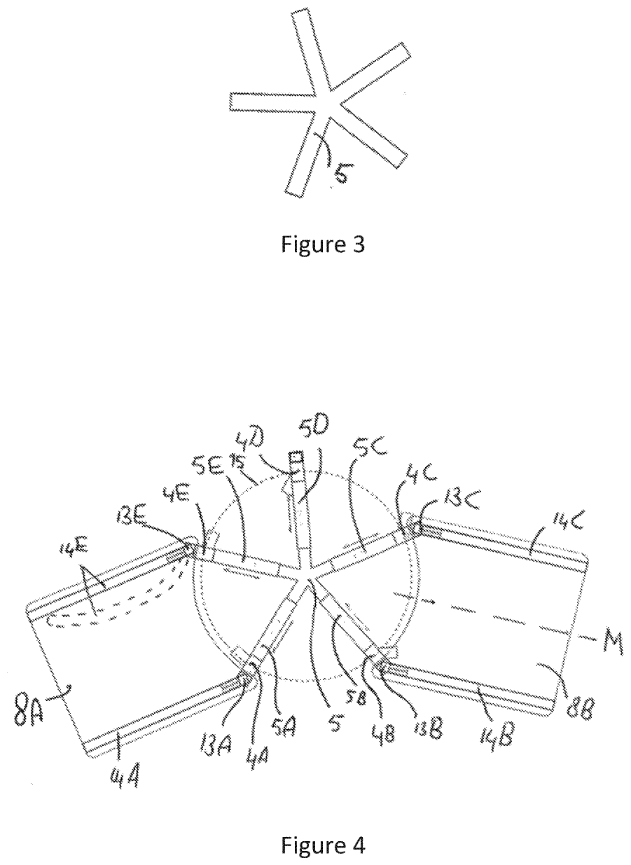

FIG. 3 shows a top view of a star-shaped connecting element of the support frame of FIG. 2;

FIG. 4 shows a top view of a support frame of the assembly of FIG. 2;

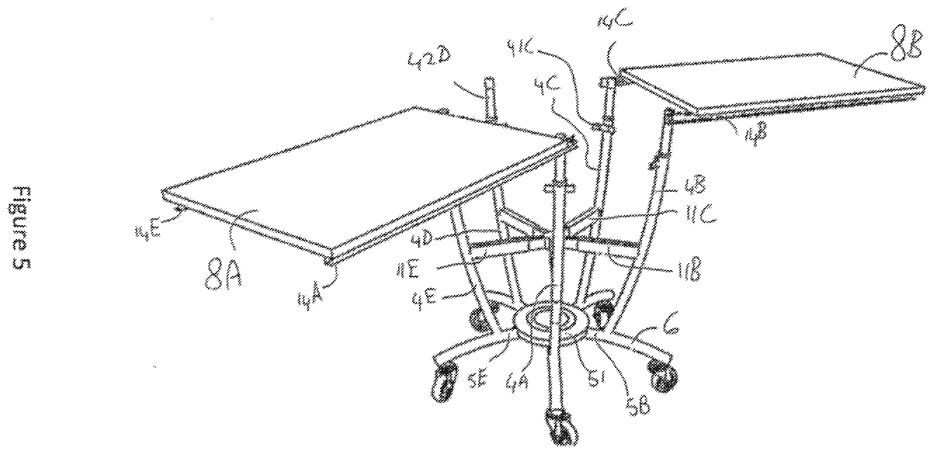

FIG. 5 shows a view in perspective of a support frame of an assembly according to the invention; and

FIG. 6 shows a top view of the support frame of FIG. 5.

In the figures identical reference numbers are used for the same parts or constituent parts that have the same function.

FIG. 1 shows a food preparation apparatus A according to the state of the art with a bowl member 2 having a flat bottom 2A and a convexly running sidewall 2B. At its upper side, the bowl member 2 is open, but in the figure this open side is closed off by a convex lid 9 having a handle 9A. When placing the apparatus A on a flat surface, the open side runs substantially horizontally. The bowl member 2 is borne by the support frame 3, comprising four bearing parts 4A, 4B extending vertically along the height of the bowl member, which bearing elements are positioned at a regular distance from each other. The bearing elements 4A, 4B extend to beyond the bottom of the bowl member 2 and at their bottom ends are connected to a star-shaped connecting element 5, extending substantially horizontally and interconnecting the four bearing elements 4A, 4B via arms 5A, 5B, 5C and 5D. At their outer ends that are oriented downward, the bearing elements 4A, 4B comprise base elements 6 that are configured as casters. Two bearing surfaces 8 designed as shelves are attached to the bowl member via a ring 7, the bearing surfaces extending substantially parallel to the open side, that means substantially horizontally, from the bowl member to the outside. These bearing surfaces 8 are not supported by bearing elements 4A, 4B of the support frame 3. The bowl member defines an internal heating space, in which fuel such as charcoal or briquettes can be placed and lit. The heating space situated within the bowl member 2 can be provided with fresh air via a damper 10A. A gridiron can be placed on the open upper side of the bowl member, on which gridiron the food to be prepared such as meat can be put. A thermometer 9B for monitoring the temperature in the heating space is incorporated in the lid 9. At the upper side, the lid 9 is bounded by a ventilation opening 9C.

In FIG. 2 a cross-section of a food preparation apparatus B is shown, in which dotted lines indicate a bowl member 2 including heating space 10 and lid 9, which bowl member 2 is accommodated in a support frame 3. The support frame 3 comprises a number of bearing elements 4A, 4B placed at a regular distance from each other and extending vertically along the height of the bowl member 2, which bearing elements extend beyond the bottom of the bowl member. The bearing elements 4A, 4B are interconnected via a first connecting element 11 extending substantially horizontally and on which the bottom of the bowl member 2 rests. First connecting element 11 is made of square profile material, from which arms 11A, 11B can be extended and retracted (shown by the horizontal arrow), because such arms are made of a larger square profile material in order for the arms 11A, 11B to be slidable. At the bottom side the bearing elements 4A, 4B are interconnected via a second connecting element 5 having slidable arms 5A, 5B. Because the arms 4A, 4B of the first connecting element 4 and the arms 5A, 5B of the second connecting element 5 are designed so as to be slidable, the distance between the bearing elements 4A and 4B can be varied, depending on the dimensions of the bowl member 2.

The bearing parts 4A, 4B comprise an interior bearing part 4A1, 4B1 extending substantially along the wall of the bowl member, as well as an exterior bearing part 4A2, 4B2 extending substantially at 90° to the plane of the open side of the bowl member 2. This plane is indicated by a dotted line 12. Exterior bearing parts 4A2, 4B2 thus substantially extend purely vertically. At the bottom side the bearing parts 4A1, 4A2, 4B1, 4B2 are interconnected via the second connecting element 5, as well as to base elements 6 configured as casters.

The presence of interior and exterior bearing parts ensures that the support frame, in which the bowl member is accommodated in a secured manner, is very sturdy. However, either the interior or exterior bearing parts can be dispensed with in the support frame, as a result of which the bearing elements are constituted by either the interior or the exterior bearing parts. Via additional connecting elements, they can be reinforced to each other and/or to the horizontal connecting elements. Bearing part 4A, 4B is connected to an angular element 13A, 13B, which angular element comprises an arm 14A, 14B extending substantially parallel to the open side of the bowl member. The shelves 8A and 8B rest on the arms 14A and 14B, respectively. The bearing elements 4A, 4B thus directly support the shelves, as a result of which they are capable of withstanding considerably more downward forces than the shelves in FIG. 1.

FIG. 3 shows a connecting part 5 with five arms, with which five bearing elements that are positioned at a regular distance from each other are interconnected.

FIG. 4 shows an exploded top view of the apparatus shown in FIG. 2, wherein for the sake of clarity connecting element 11 is not shown, so that in this figure the connecting element 5 is looked down onto. Arrows indicate the slidability of arms 5A-E of connecting element 5. The dotted circle 15 represents the annular cross-section of the open upper side of the bowl member. Bearing elements 4A, B, C and E are each time connected to an angular element 13A, B, C and E. Both shelves 8A and 8B are supported by two adjacent bearing elements 4A and 4E, 4B and 4C via angular elements 13A and E, 13B and C by arms 14A, E, B and C. M indicates the axial line of the shelf 8B. The bearing elements support the shelves on either side of its axial line.

The angular elements can be connected to the bearing elements so as to be detachable and/or rotatable. The arms of the angular elements may also have a curvature corresponding to the curvature of the outer circumference of the bowl member. In that way the arms can easily be rotated against the bowl member to save space when the apparatus is stowed away. The two adjacent arms 13A and 13E, and arms 13B and 13C can all be rotated in the same direction (clockwise or anticlockwise). The curvature for arm 14E is shown in dotted lines, wherein the arm can be rotated clockwise against the bowl member. Preferably, the bowl member is placed such in the support frame that any hinge between a present lid and the bowl member is placed at the rear side of the frame, that means placed above the bearing element 4D.

FIG. 5 shows an alternative support frame for an assembly according to the invention, wherein the vertical tubular bearing elements 4A-E extend vertically and are curved such as to follows the curvature of the exterior of the sidewall of a bowl member (not shown). The bottom side comprises base elements 6, which are provided with castors. At the upper end the bearing elements 4A, 4B, 4C, and 4E comprise horizontal bearing arms 14A, 14B, 14C and 14E, respectively, that are connected thereto, and that are designed so as to hinge vertically. Shelf 8A rests on bearing arms 14A and 14E, shelf 8B rests on bearing arms 14B and 14C. The shelves can either be hinged upwards or downwards so as to be able to fold the shelves in and out, respectively. Each bearing element 4A-E is provided with a lip 41A-E that is only shown for bearing arm 4C, and therefore indicated by 41C. Said lips form an additional support for the bowl member. At their upper sides, bearing elements 4A-4E comprise an extendable portion 42A-E which is only shown for bearing elements 4B and 4D, and therefore indicated by 42B and 42D, respectively. As a consequence, the bearing elements can be adjusted in height. This is particularly advantageous for bearing elements comprising a bearing arm for supporting a shelf, in order to be able to adjust their height. However, the adjustability of in this case bearing element 4D is advantageous due to the possibility of accommodating different sizes of bowl members. First connecting elements 11A-E, against which the bottom of the bowl member will rest when it is placed in the support frame, are interconnected by a cross-shaped element 52. Second connecting elements 5A-E are interconnected by a disk-shaped connecting element 51.

1-22. (canceled)

23. Assembly of a support frame and a food preparation apparatus, which food preparation apparatus comprises a bowl member the upper side of which is open, which bowl member comprises a bottom and a convexly running sidewall and which has a substantially annular cross-section at the open upper side, wherein the bowl member defines an internal heating space, wherein the bowl member is borne by the support frame that is provided with vertically extending bearing elements that are interconnected by one or more horizontally extending connecting elements, which bearing elements comprise base elements at their bottom sides, on which bearing elements the assembly, when being used, rests on the ground, wherein the support frame comprises five bearing elements that are positioned at a regular distance from each other and extend vertically along the height of the bowl member, which bearing elements bear and secure the bowl member in the support frame.

24. Assembly according to claim 23, wherein the horizontally extending connecting elements comprise one or more first connecting elements extending such at the location of the bottom side of the bowl member that the bottom of the bowl member rests on the first connecting elements.

25. Assembly according to claim 23, wherein the support frame comprises second connecting elements, which second connecting elements are placed below and spaced apart from the bottom of the bowl member.

26. Assembly according to claim 23, wherein the one or more connecting elements comprise one or more slidable arms.

27. Assembly according to claim 23, wherein the a bearing elements extend substantially along the sidewall of the bowl member.

28. Assembly according to claim 27, wherein the bearing elements are curved such that they at least in part follow the contours of the exterior of the sidewall.

29. Assembly according to claim 23, wherein the bearing elements extend at substantially 90° to the plane of the open side of the bowl member.

30. Assembly according to claim 23, wherein a bearing element comprises an interior bearing part extending substantially along the sidewall of the bowl member, and is connected to an exterior bearing part extending at substantially 90° to the plane of the open side of the bowl member.

31. Assembly according to claim 23, which assembly at the outer circumference of the bowl member at least comprises a bearing surface extending to the outside and substantially parallel to the open side of the bowl member, wherein one or more bearing elements support the at least one bearing surface.

32. Assembly according to claim 31, wherein the support frame supports two bearing surfaces that are positioned opposite each other.

33. Assembly according to claim 31, wherein two bearing elements that are situated next to each other each support a bearing surface on either side of its axial line.

34. Assembly according to claim 31, wherein the one or more bearing elements supporting the bearing surface extend as far as the open side of the bowl member.

35. Assembly according to claim 31, wherein the one or more bearing elements supporting the bearing surface can be adjusted in height.

36. Assembly according to claim 31, wherein the one or more bearing elements supporting the bearing surface each comprise a bearing arm, which bearing arm extends substantially parallel to the open side of the bowl member, on which bearing arm the bearing surface is positioned.

37. Assembly according to claim 36, wherein the one or more bearing elements supporting the bearing surface each comprise an angular element, which angular element is connected to a bearing arm.

38. Assembly according to claim 37, wherein the angular element is configured so as to be rotatable relative to the bowl member, the arm of the angular element having a curvature that substantially corresponds to the outer circumference of the bowl member at the location of the angular element.

39. Assembly according to claim 37, wherein the angular element is designed so as to be detachable from the bearing element.

40. Assembly according to claim 23, wherein the food preparation apparatus comprises a lid with which the open side of the bowl member can be closed off.

41. Assembly according to claim 23, wherein the food preparation apparatus is designed like a kamado-type grill.

42. The support frame of an assembly of a support frame and a food preparation apparatus, which food preparation apparatus comprises a bowl member the upper side of which is open, which bowl member comprises a bottom and a convexly running sidewall and which has a substantially annular cross-section at the open upper side, wherein the bowl member defines an internal heating space, wherein the bowl member is borne by the support frame that is provided with vertically extending bearing elements that are interconnected by one or more horizontally extending connecting elements, which bearing elements comprise base elements at their bottom sides, on which bearing elements the assembly, when being used, rests on the ground, wherein the support frame comprises five bearing elements that are positioned at a regular distance from each other and extend vertically along the height of the bowl member, which bearing elements bear and secure the bowl member in the support frame.
